(19) United States
(12) Patent Application Publication
(10) Pub. No.: US 2008/0150873 A1
(43) Pub. Date: Jun. 26, 2008

(54) Liquid crystal display device and driving method of the same

(75) Inventor: Gi-Hong Kim, Annyang-si (KR)

Correspondence Address: MCKENNA LONG & ALDRIDGE LLP, 1900 K STREET, NW, WASHINGTON, DC, 20006, US

(73) Assignee: LG. PHILIPS LCD CO., LTD., Youngdungpo-gu (KR)

(21) Appl. No.: 12/004,520

(22) Filed: Dec. 21, 2007

(30) Foreign Application Priority Data
Dec. 22, 2006 (KR) 2006-0132848

(51) Int. Cl. G09G 3/36

(52) U.S. Cl. 345/99

(57) ABSTRACT

A liquid crystal display device driven by a N-line inversion driving method, in which N odd horizontal lines and N even horizontal lines are alternately driven, wherein N is a natural number larger than 1, includes a liquid crystal panel including pixels, gate and data drivers providing gate driving signals and data signals to the pixels, a timing controller receiving control signals and video signals from an outer system and controlling the gate and data drivers according to the control signals, wherein the timing controller changes an order of the video signals every frame and supplies the video signals to the data driver, a frame memory unit connected to the timing controller and storing the video signals of each frame, and a common voltage generator providing a common voltage to the liquid crystal panel.

This application claims the benefit of Korean Patent Application No. 2006-0132848 filed in Korea on Dec. 22, 2006, which is hereby incorporated by reference for all purposes as if fully set forth herein.

### BACKGROUND OF THE INVENTION

1. Field of the Invention

The invention relates to a liquid crystal display device, and more particularly, to a liquid crystal display device driven by an N-line inversion driving method and a driving method of the same.

2. Discussion of the Related Art

Among various types of liquid crystal display devices, active matrix liquid crystal display devices have been widely used because of their high resolution and superior ability in displaying moving images. In an active matrix liquid crystal display device, a thin film transistor (TFT) is formed as a switching element at each pixel and controls voltage levels of the pixel, thereby changing light transmittance of the pixels to display images.

Hereinafter, a related art active matrix liquid crystal display device will be described with reference to FIG. 1.

FIG. 1 is a view of schematically illustrating a related art active matrix liquid crystal display device.

In FIG. 1, the liquid crystal display device includes a liquid crystal panel 1 for displaying images, driving circuits 2 and 4 for driving the liquid crystal panel 1, a timing controller 6 for controlling the driving circuits 2 and 4, and a common voltage generator 8 for supplying a common voltage Vcom.

In the liquid crystal panel 1, gate lines GL1 to GLn (n is a natural number) and data lines DL1 to DLm (m is a natural number) cross each other to define pixels arranged in a matrix. A thin film transistor TFT and a liquid crystal capacitor Clc are formed at each pixel as a switching element and a liquid crystal cell, respectively. The liquid crystal capacitor Clc includes a pixel electrode (not shown) and a common electrode (not shown) for generating an electric field. The thin film transistor TFT electrically connects a corresponding one of data lines DL1 to DLm with the pixel electrode according to gate driving signals supplied through the gate lines GL1 to GLn.

The driving circuits 2 and 4 include a gate driver 2 for driving the gate lines GL1 to GLn and a data driver 4 for driving the data lines DL1 to DLm. Here, the gate driver 2 sequentially provides gate driving signals to the gate lines GL1 to GLn during a frame. Accordingly the liquid crystal capacitors Clc of the liquid crystal panel 1 are sequentially driven one horizontal line by one horizontal line. The data driver 4 supplies data signals to the data lines DL1 to DLm to thereby charge the pixel electrodes of the liquid crystal capacitors Clc.

The timing controller 6 includes a control signal generator (not shown) and a data processor (not shown). The control signal generator generates driver control signals for controlling the gate driver 2 and the data driver 4. The data processor aligns video signals input from an external source according to a driving method and structure of the liquid crystal panel 1. The timing controller 6 provides the driving circuits 2 and 4 with the driver control signals and the aligned video signals corresponding to the video signals input from the external source.

The common voltage generator 8 generates a common voltage Vcom, which is an opposite voltage to the video signal of the pixel electrode, and supplies the common voltage Vcom to the common electrode on the liquid crystal panel 1.

If voltages having the same polarities are continuously applied to the pixel electrode and the common electrode, the liquid crystal between the pixel electrode and the common electrode may be degraded to cause flickering or dimming of the image. Accordingly, the liquid crystal display device may be driven using an inversion driving method, such as a line inversion driving method or a dot inversion driving method, which inverts the polarity of the data signals whenever the frame is changed.

FIG. 2A and FIG. 2B are views for explaining a line inversion driving method of driving a liquid crystal display device. FIG. 3A and FIG. 3B are views for explaining a dot inversion driving method of a liquid crystal display device.

In the line inversion driving method, polarities of the data signals applied to the liquid crystal panel are inverted for every gate line and for every frame, as illustrated in FIG. 2A and FIG. 2B, respectively. The liquid crystal display device is driven by low voltages. However, the line inversion driving method has a problem that there exists crosstalk between pixels horizontally arranged, thereby causing flicker.

In the dot inversion driving method, data signals having opposite polarities to the data signals applied to the pixels horizontally or vertically adjacent to one another, and the data signals applied to any pixel are inverted every frame, as illustrated in FIG. 3A and FIG. 3B. Since polarities of the data signals applied to the pixels from the data driver are inverted in both the horizontal and vertical directions, a variation in the video signals charged into the pixel electrode is relatively large as compared with the line inversion driving method. As a result, using the dot inversion driving method causes an increase in power consumption.

Recently, an N-line inversion driving method has been proposed in which N odd horizontal lines and N even horizontal lines are alternately driven to lower output frequency of the data driver and decrease power consumption, wherein N is a natural number larger than 1.

FIG. 4A and FIG. 4B are views illustrating an N-line inversion driving method of a liquid crystal display device and show a gate driving signal V_{G} and a data signal V_{DATA} at first and second frames, respectively. For example, N may be two, and 2-line inversion driving method may be applied.

In FIG. 4A and FIG. 4B, the gate driving signal V_{G} is input through first, second, third and fourth gate lines GL1, GL2, GL3 and GL4 at each of first and second frames F1 and F2. Here, odd horizontal lines, that is, the first and third gate lines GL1 and GL3 are first driven in sequence, and then even horizontal lines, that is, the second and fourth gate lines GL2 and GL4 are driven in sequence.

Although not shown in the figures, following the driving of the first, third, second, and fourth gate lines, the fifth and seventh gate lines are driven, and then the sixth and eighth gate lines are driven.

In the 2-line inversion driving method, the gate driving signal V_{G} is input to the first gate line GL1, and first horizontal line pixels, which correspond to the first gate line GL1, are charged. Next, the gate driving signal V_{G} is input to the third gate line GL3, and third horizontal line pixels, which correspond to the third gate line GL3, are charged. The data signal V_{DATA} provided to the third horizontal line pixels from the data driver has the same polarity as that provided to the first horizontal line pixels, and the data signal V_{DATA} provided to the fourth horizontal line pixels from the data driver has the same polarity as that provided to the second horizontal line pixels. For example, during the first frame F1, positive voltages are applied to the first horizontal line pixels and the third horizontal line pixels, and negative voltages are applied to the second horizontal line pixels and the fourth horizontal line pixels. During the second frame F2, negative voltages are applied to the first horizontal line pixels and the third horizontal line pixels, and positive voltages are applied to the second horizontal line pixels and the fourth horizontal line pixels. Therefore, the output frequency of the data driver is lowered, and the power consumption is decreased.

However, during the first frame F1, because the pixels corresponding to the third gate line GL3 are charged with the positive voltage, which has the same polarity as the previously charged pixels, the pixels corresponding to the third gate line GL3 are charged substantially without signal delay. On the other hand, the pixels corresponding to the second gate line GL2 are charged with the negative voltage, which has the opposite polarity to the previously charged pixels, and at this time, there exists the signal delay. Accordingly, the charged amount a1 of the pixels corresponding to the third gate line GL3 is larger than the charged amount b1 of the pixels corresponding to the second gate line GL2.

Similarly, during the second frame F2, the charged amount a2 of the pixels corresponding to the third gate line GL3 is larger than the charged amount b3 of the pixels corresponding to the second gate line GL2.

The difference between the charged amounts is sensed by an observer as a horizontal line dim phenomenon that lowers image quality.

### SUMMARY OF THE INVENTION

Accordingly, the present invention is directed to a liquid crystal display device and a driving method of the same that substantially obviate one or more of the problems due to limitations and disadvantages of the related art.

An advantage of the present invention is to provide an N-line inversion liquid crystal display device and a driving method of the same that reduces or eliminates a line dim phenomenon.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of embodiments of the invention, as embodied and broadly described, a liquid crystal display device driven by a N-line inversion driving method, in which N odd horizontal lines and N even horizontal lines are alternately driven, wherein N is a natural number larger than 1, includes a liquid crystal panel including pixels, gate and data drivers providing gate driving signals and data signals to the pixels, a timing controller receiving control signals and video signals from an outer system and controlling the gate and data drivers according to the control signals, wherein the timing controller changes an order of the video signals every frame and supplies the video signals to the data driver, a frame memory unit connected to the timing controller and storing the video signals of each frame, and a common voltage generator providing a common voltage to the liquid crystal panel.

In another aspect of the invention, a driving method of a liquid crystal display device, which includes a liquid crystal panel having pixels, gate and data drivers controlling the pixels, a timing controller controlling the gate and data drivers, changing an order of video signals every frame and supplying the video signals to the data driver, and a frame memory unit storing the video signals of each frame, wherein the liquid crystal display device is driven by a N-line inversion driving method in which N odd horizontal lines and N even horizontal lines are alternately driven, wherein N is a natural number larger than 1, includes storing the video signals of Mth frame (M is a natural number) into a first frame memory of the frame memory unit, supplying the data driver with the video signals of the Mth frame in a first order, storing the video signals of (M+1)th frame into a second frame memory of the frame memory unit, and supplying the data driver with the video signals of the (M+1)th frame in a second order.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1 is a view schematically illustrating a related art active matrix liquid crystal display device;

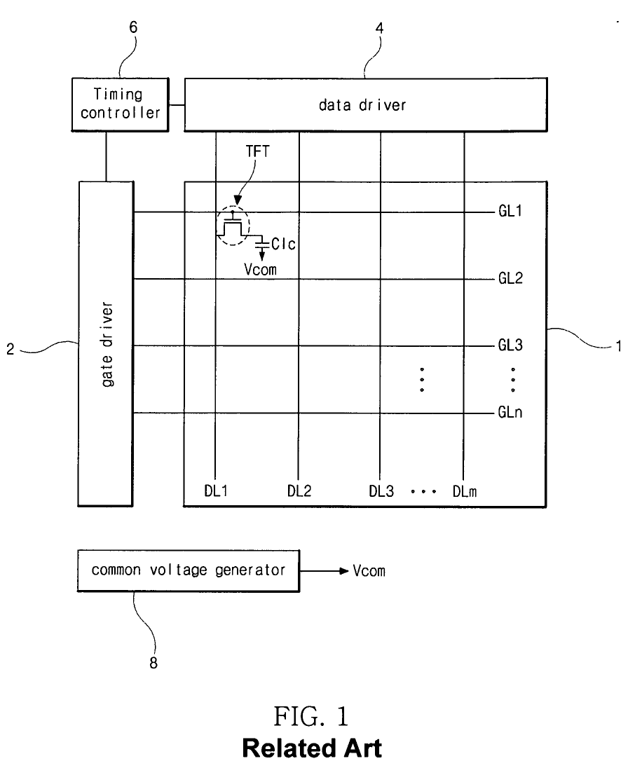

FIG. 2A and FIG. 2B are views for explaining a line inversion driving method of a liquid crystal display device;

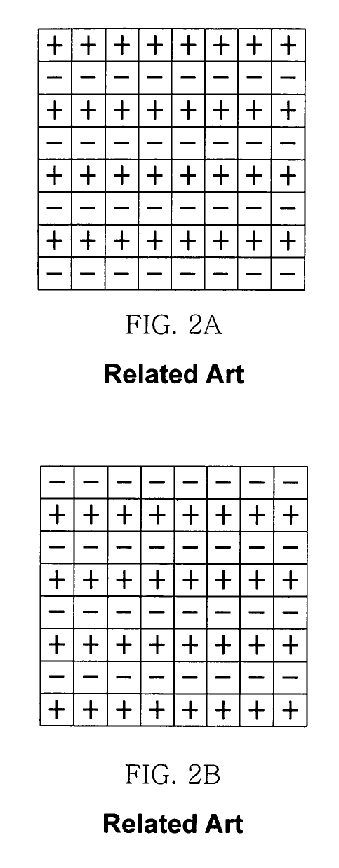

FIG. 3A and FIG. 3B are views for explaining a dot inversion driving method of a liquid crystal display device;

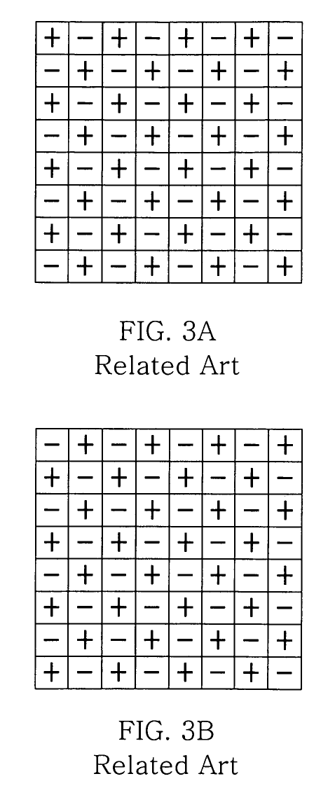

FIG. 4A and FIG. 4B are views illustrating an N-line inversion driving method of a liquid crystal display device;

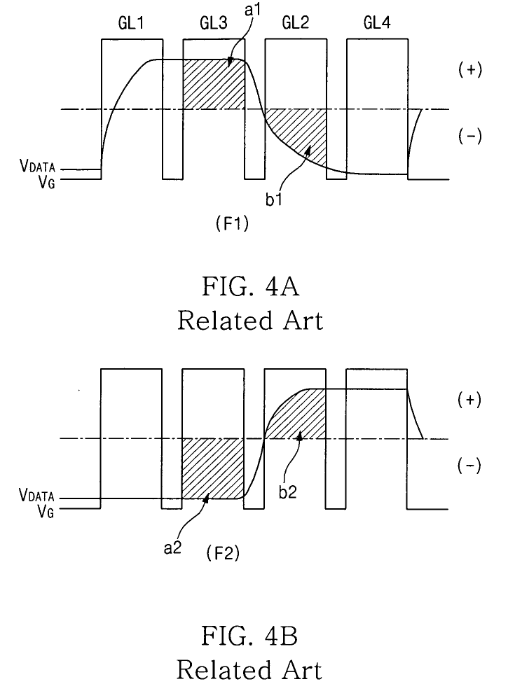

FIG. 5 is a view schematically illustrating a liquid crystal display device according to an embodiment of the present invention; and

FIG. 6A and FIG. 6B are views illustrating a 2-line inversion driving method of a liquid crystal display device according to the present invention.

### DETAILED DESCRIPTION OF THE ILLUSTRATED EMBODIMENTS

Reference will now be made in detail to embodiments of the present invention, an example of which is illustrated in the accompanying drawings.

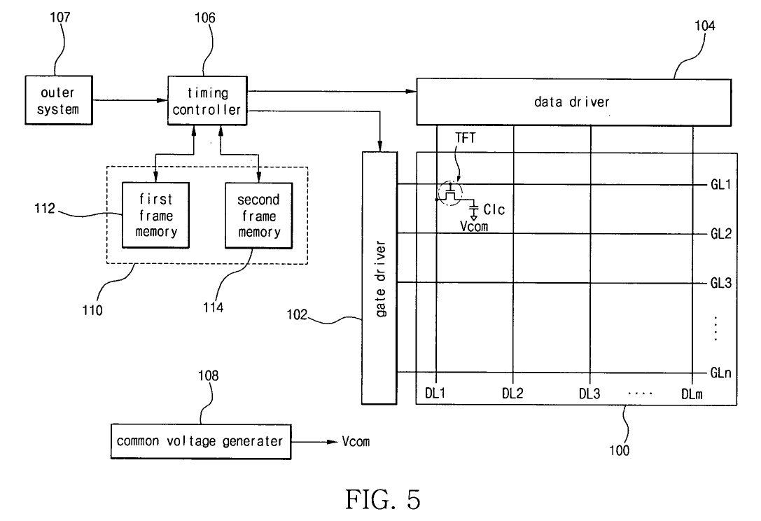

FIG. 5 is a view of schematically illustrating a liquid crystal display device according to an embodiment of the present invention. The liquid crystal display device may be driven by a 2-line inversion driving method. Other N-line inversion driving methods (where N is a natural number) can be applied to the liquid crystal display device according to the embodiment of the present invention.

In FIG. 5, the liquid crystal display device includes a liquid crystal panel 100 for displaying images, driving circuits 102 and 104 for driving the liquid crystal panel 100, a timing controller 106 for controlling the driving circuits 102 and 104, and a common voltage generator 108 for supplying a common voltage Vcom to the liquid crystal panel 100.

In the liquid crystal panel 100, gate lines GL1 to GLn (n is a natural number) and data lines DL1 to DLm (m is a natural number) cross each other to define pixels, which are arranged in a matrix shape. A thin film transistor TFT and a liquid crystal capacitor Clc are formed at each pixel as a switching element and a liquid crystal cell, respectively. The liquid crystal capacitor Clc includes a pixel electrode and a common electrode for generating an electric field with liquid crystal is interposed between the pixel electrode and the common electrode. The thin film transistor TFT electrically connects a corresponding one of data lines DL1 to DLm with the pixel electrode in response to gate driving signals supplied through the gate lines GL1 to GLn.

The driving circuits 102 and 104 include a gate driver 102 for driving the gate lines GL1 to GLn and a data driver 104 for driving the data lines DL1 to DLm.

More particularly, the gate driver 102 sequentially provides gate driving signals to the gate lines GL1 to GLn during a frame and controls turn-on/off of the pixels electrically connected to the gate lines GL1 to GLn. The data driver 104 supplies data signals to the data lines DL1 to DLm to thereby charge the pixel electrodes of the pixels, which turn on by the gate driving signals from the gate driver 102.

During a first frame, first, third, second and fourth gate lines GL1, GL3, GL2 and GL4 are sequentially driven. During the subsequent second frame, the fourth, second, third and first gate lines GL4, GL2, GL3 and GL1 are sequentially driven according to an opposite order to the first frame.

The timing controller 106 receives control signals from an outer system 107. The timing controller 106 generates driver control signals for driving the gate driver 102 and the data driver 104 according to the control signals and provides the driver control signals to the gate driver 102 and the data driver.

In addition, the timing controller 106 receives video signals and stores the video signals into a frame memory unit 110.

The frame memory unit 110 includes at least two frame memories. The number of frame memories depends on the value of N in the N-line inversion driving method. For example, in the 2-line inversion driving method, the frame memory unit 110 includes first and second frame memories 112 and 114.

The first and second frame memories 112 and 114 temporarily store video signals of a Mth frame (where M is a natural number) and a (M+1)th frame provided to the timing controller 106 from the outer system 107, respectively, and input the video signals into the timing controller 106 again.

During the Mth frame, the timing controller 106 supplies the data driver 104 with the video signals stored in the first frame memory 112 sequentially one horizontal line by one horizontal line. Because the liquid crystal display device is driven by the 2-line inversion driving method in the illustrated example, the video signals are provided in an order of first, third, second and fourth horizontal lines.

Next, during the (M+1)th frame, the timing controller 106 supplies the data driver 104 with the video signals stored in the second frame memory 114 sequentially one horizontal line by one horizontal line. The video signals are provided in an order of the fourth, second, third and first horizontal lines, which is the inverse of the order during the Mth frame.

Accordingly, the charging orders of pixels corresponding to the second and third horizontal lines alternate with each other during the Mth frame and the (M+1)th frame. As a result, the difference between charged amounts of the pixels decreases.

The common voltage generator 108 generates the common voltage Vcom having polarity opposite to the data signal applied to the pixel electrode and supplies the common voltage Vcom to the common electrode of the liquid crystal panel 100.

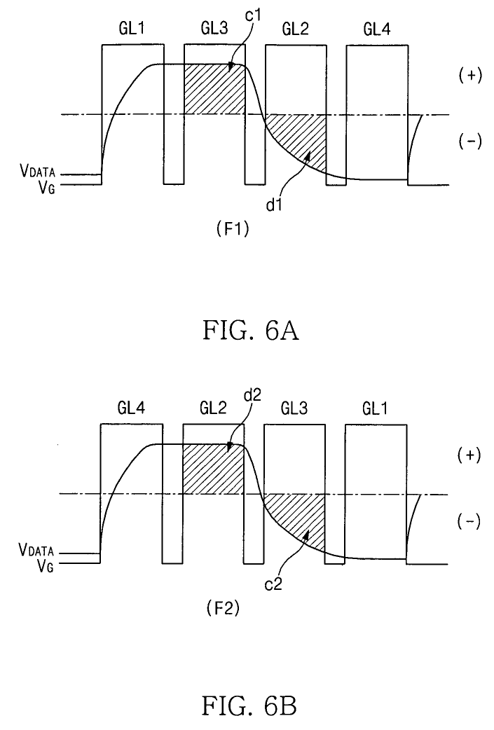

FIG. 6A and FIG. 6B are views illustrating a 2-line inversion driving method of a liquid crystal display device according to the present invention and show a gate driving signal V_{G} and a data signal V_{DATA} for first and second frames, respectively.

In FIG. 6A, the gate driving signal V_{G} is input through first, second, third and fourth gate lines GL1, GL2, GL3 and GL4 during the first frame F1. As illustrated, odd horizontal lines, that is, the first and third gate lines GL1 and GL3 are driven in sequence after which the even horizontal lines, that is, the second and fourth gate lines GL2 and GL4 are driven in sequence.

Next the fifth and seventh gate lines are driven, after which sixth and eighth gate lines are driven. Continuing in this fashion, all of the gate lines are driven during the first frame F1.

The gate driving signal V_{G} is input to the first gate line GL1, and first horizontal line pixels, which correspond to the first gate line GL1, are charged. Next, the gate driving signal V_{G} is input to the third gate line GL3, and third horizontal line pixels, which correspond to the third gate line GL3, are charged. At this time, the data signal V_{DATA} provided to the third horizontal line pixels from the data driver has the same polarity as that provided to the first horizontal line pixels.

Next, the gate driving signal V_{G} is input to the second gate line GL2, and second horizontal line pixels, which correspond to the second gate line GL2, are charged. After that, the gate driving signal V_{G} is input to the fourth gate line GL4, and fourth horizontal line pixels, which correspond to the fourth gate line GL4, are charged. Here, the data signal V_{DATA} provided to the second horizontal line pixels has an opposite polarity to that provided to the third horizontal line pixels, and the data signal V_{DATA} provided to the fourth horizontal line pixels has the same polarity as that provided to the second horizontal line pixels.

In other words, during the first frame F1, positive voltages are applied to the first horizontal line pixels and the third horizontal line pixels, and negative voltages are applied to the second horizontal line pixels and the fourth horizontal line pixels.

The third horizontal line pixels are charged with the positive voltage, which has the same polarity as the previously charged pixels, and the second horizontal line pixels are charged with the negative voltage, which has the opposite polarity to the previously charged pixels. Accordingly, the charged amount c1 of the third horizontal line pixels is larger than the charged amount dl of the second horizontal line pixels.

Next, during the second frame F2 of FIG. 6B, the gate driving signal V_{G} is input to the fourth gate line GL4, and the fourth horizontal line pixels are charged. Next, the gate driving signal V_{G} is input to the second gate line GL2, and the second horizontal line pixels are charged. At this time, the data signal V_{DATA} provided to the second horizontal line pixels from the data driver has the same polarity as that provided to the fourth horizontal line pixels, for example, a positive polarity.

Next, the gate driving signal V_{G} is input to the third gate line GL3, and the third horizontal line pixels are charged. Then, the gate driving signal V_{G} is input to the first gate line GL1, and the first horizontal line pixels are charged. Here, the data signal V_{DATA} provided to the third horizontal line pixels has an opposite polarity to that provided to the second horizontal line pixels, and the data signal V_{DATA} provided to the first horizontal line pixels has the same polarity as that provided to the third horizontal line pixels, for example, a negative polarity.

During the second frame F2, the second horizontal line pixels are charged with the positive voltage, which has the same polarity as the previously charged pixels, and the third horizontal line pixels are charged with the negative voltage, which has the opposite polarity to the previously charged pixels. Accordingly, the charged amount d2 of the second horizontal line pixels is larger than the charged amount c2 of the third horizontal line pixels.

The charged amount dl of the second horizontal line pixels during the first frame F1 is relatively small due to the data signal V_{DATA} that has the opposite polarity to that applied to the previously charged pixels, and the charged amount d2 of the second horizontal line pixels during the second frame F2 is relatively large due to the data signal V_{DATA} that has the same polarity as that applied to the previously charged pixels.

On the other hand, the charged amount c1 of the third horizontal line pixels during the first frame F1 is relatively large due to the data signal V_{DATA} that has the same polarity as that applied to the previously charged pixels, and the charged amount c2 of the third horizontal line pixels during the second frame F2 is relatively small due to the data signal V_{DATA} that has the opposite polarity to that applied to the previously charged pixels.

Therefore, during the first and second frames F1 and F2, a total charged amount d1+d2 of the second horizontal line pixels substantially equals to a total charged amount c1+c2 of the third horizontal line pixels, and the problem of the horizontal line dim phenomenon is improved.

In the present invention, a liquid crystal display device is driven by an N-line inversion driving method, and the charging order of the horizontal lines at a previous frame is inverted at a following frame. Accordingly, the horizontal line dim phenomenon may be reduced or eliminated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

What is claimed is:

1. A liquid crystal display device driven by a N-line inversion driving method in which N odd horizontal lines and N even horizontal lines are alternately driven, wherein N is a natural number larger than 1, the device comprising:
a liquid crystal panel including pixels;
gate and data drivers providing gate driving signals and data signals to the pixels;
a timing controller receiving control signals and video signals from an external system and controlling the gate and data drivers according to the control signals, wherein the timing controller changes an order of the video signals every frame and supplies the video signals to the data driver;
a frame memory unit connected to the timing controller and storing the video signals of each frame; and
a common voltage generator providing a common voltage to the liquid crystal panel.

2. The device according to claim 1, wherein the frame memory unit includes first and second frame memories that store the video signals corresponding to Mth frame (where M is a natural number) and the video signals corresponding to (M+1)th frame, respectively.

3. The device according to claim 2, wherein the order of the video signals provided to the data driver during the Mth frame is opposite to the order of the video signals provided to the data driver during the (M+1)th frame.

4. The device according to claim 1, wherein two odd horizontal lines and two even horizontal lines are alternately driven.

5. The device according to claim 4, wherein the order of the video signals provided to the data driver at Mth frame (where M is a natural number) corresponds to an order of Kth, (K+2)th, (K+1)th and (K+3)th horizontal lines (where K is a natural number), and the order of the video signals provided to the data driver at (M+1)th frame corresponds to an order of the (K+3)th, (K+1)th, (K+2)th and Kth horizontal lines gate electrode extends from the first gate line, and the organic semiconductor layer extends under the first gate line.

6. A driving method of a liquid crystal display device, which includes a liquid crystal panel having pixels, gate and data drivers controlling the pixels, a timing controller controlling the gate and data drivers, changing an order of video signals every frame and supplying the video signals to the data driver, and a frame memory unit storing the video signals of each frame, wherein the liquid crystal display device is driven by a N-line inversion driving method in which N odd horizontal lines and N even horizontal lines are alternately driven, wherein N is a natural number larger than 1, the driving method comprising:
storing the video signals of Mth frame (M is a natural number) into a first frame memory of the frame memory unit;
supplying the data driver with the video signals of the Mth frame in a first order;
storing the video signals of (M+1)th frame into a second frame memory of the frame memory unit; and
supplying the data driver with the video signals of the (M+1)th frame in a second order.

7. The driving method according to claim 6, wherein the first order corresponds to an order of the N odd horizontal lines and the N even horizontal lines, and the second order corresponds to an order of the N even horizontal lines and the N odd horizontal lines.

8. The driving method according to claim 6, wherein the first order of the video signals provided to the data driver during the Mth frame is opposite to the second order of the video signals provided to the data driver during the (M+1)th frame.

9. The driving method according to claim 6, wherein two odd horizontal lines and two even horizontal lines are alternately driven.

10. The driving method according to claim 9, wherein the video signals of the Mth frame are provided to the data driver in the first order corresponding to Kth (K is a natural number), (K+2)th, (K+1)th and (K+3)th horizontal lines, and the video signals of the (M+1)th frame are provided to the data driver in the second order corresponding to (K+3)th, (K+1)th, (K+2)th and Kth horizontal lines.

11. The driving method according to claim 10, wherein during the Mth frame, the video signals corresponding to the Kth and (K+2)th horizontal lines have a first polarity, and the video signals corresponding to (K+1)th and (K+3)th horizontal lines have a second polarity opposite to the first polarity.

12. The driving method according to claim 11, wherein during the (M+1)th frame, the video signals corresponding to the (K+3)th and (K+1)th horizontal lines have the first polarity, and the video signals corresponding to (K+2)th and Kth horizontal lines have the second polarity.
